(19) United States
(12) Patent Application Publication
(10) Pub. No.: US 2009/0217296 A1
(43) Pub. Date: Aug. 27, 2009

(54) BENEFIT ANALYSIS OF IMPLEMENTING VIRTUAL MACHINES

(76) Inventors: Alexander Gebhart, Akazienweg (DE); Erol Bozak, Vinzentiusstrasse (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 12/037,871

(22) Filed: Feb. 26, 2008

(51) Int. Cl. G06F 3/00

(52) U.S. Cl. 719/317

(57) ABSTRACT

Methods and apparatus, including computer program products, are provided for determining the benefit of implementing virtualization technology. In one aspect, there is provided a computer-implemented method for determining the benefit of implementing virtualization technology. The method may include receiving information gathered using one or more agents. Based on the received information gathered using the one or more agents, an indication of whether there is a benefit to implementing one or more virtual machines may be determined. The indication may be provided to a user interface. Related apparatus, systems, methods, and articles are also described.

### FIELD

The present disclosure generally relates to virtual machines and, in particular, providing information representing the benefit of implementing virtual machines.

### BACKGROUND

Computers have now become an integral part of our society both in business and in residential settings. Almost every business of sufficient size in Germany, the United States, and other developed countries has one or more computers to assist them in running their businesses. Similarly, many families in those countries now have computers at home that are used to run various applications including games.

Some attribute the popularity of the computers to the Internet. The Internet provides people with a ready access to vast amounts of data. Many people now get their news, sports, stock, entertainment, and other information primarily from the Internet. Businesses have also embraced the Internet. The Internet provides the opportunity for computers to communicate instantly with other computers or individuals. Business processes that were once restricted to intranets and their users are now moving to the Internet. Accordingly, companies are moving more and more of their data to electronic forms. In addition, companies have amassed huge amounts of data in an effort to understand their business, improve performance, and build stronger employee, customer, and partner relationships.

Virtualization is a technology for optimizing processing at a computer. Virtualization provides a software layer that when executed allows one or more virtual machines with, in some cases, different operating systems to run side-by-side with other virtual machines running on the same physical machine (e.g., a node, computer, processor, server, and the like). A virtual machine is a machine that is defined and implemented in software rather than hardware. The virtualization software provides a so-called “container” that wraps and isolates the virtual machine from other virtual machines. For example, in a server complex including fifty physical servers, each of which hosts its own application server, virtualization permits the server complex to instead operate with, for, example, twenty-five physical servers, each of which includes virtualization software providing two virtual machines for the application servers. In both cases, fifty application servers are deployed, but with virtualization, the number of physical servers is reduced to twenty-five. Virtualization software may also control one or more of the following functions: running multiple virtual machines with different operating systems at the same time on the same physical machine; generating fully configured isolated virtual machines with a set of virtual hardware including an operating system and applications; saving, copying, and provisioning of virtual machines; and moving virtual machines from one physical machine to another physical machine for workload management.

An example of virtualization software is a hypervisor. A hypervisor is a software program that manages multiple operating systems (or multiple instances of the same operating system) on a single physical machine (e.g., a processor, a computer, a blade, and etc.). The hypervisor is thus the controller (or manager) of the physical machine's processor, memory, storage, network bandwidth, and other resources enabling the virtual environments provided by a virtual machine. Hypervisors are also referred to as virtualization managers. Commercial examples of hypervisors are VMware ESX Server and VMware Server.

### SUMMARY

The subject matter disclosed herein provides methods and apparatus, including computer program products, for providing agents for determining the benefit of implementing virtual machines.

In one aspect, there is provided a computer-implemented method for determining the benefit of implementing virtualization technology. The method may include receiving information gathered using one or more agents. Based on the received information gathered using the one or more agents, an indication of whether there is a benefit to implementing one or more virtual machines may be determined. The indication may be provided to a user interface.

Variations may include one or more of the following features. The information may be received over a predetermined period. The received information may include dynamic information and static information. The indication may be determined as a cost representative of the benefit of implementing one or more virtual machines. The indication may be provided as a graph representative of a break-even point. The one or more agents may be provided to the system, so that the one or more agents receive one or more messages exchanged in the system including one or more virtual machines. The one or more virtual machines may each include a corresponding agent. An agent may also be provided to receive one or more messages from all of the one or more virtual machines. The agent may include a filter to process a hypertext transfer protocol request. The received information may be stored in a centralized storage location. The received information may be mapped into a generic format.

The subject matter described herein may be implemented to realize the advantage of providing information representative of the benefit of implementing virtual machines. Moreover, a system may be adapted to vary (e.g., add or reduce) the quantity of virtual machines at any given time.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

In the drawings,

FIG. 1 depicts a block diagram of a system including agents and virtual machines;

FIG. 2a depicts a process for determining the benefit of implementing virtual machines;

FIG. 2b depicts another process for determining the benefit of implementing virtual machines;

FIG. 3 depicts an example of an indication which may be provided to represent the benefit of implementing virtual machines;

FIG. 4 depicts another block diagram of a system including an agent and virtual machines; and

FIG. 5 depicts an agent implemented as a so-called “filter.”

Like labels are used to refer to same or similar items in the drawings.

### DETAILED DESCRIPTION

Virtualization technologies (including hypervisor technologies) have many benefits. However, some users implement virtualization technology on a large scale without having any sense of the cost savings over traditional, physical machines. Other users are reluctant to deploy virtualization technologies because of the perceived costs associated with implementations (e.g., license fees associated with virtualization software). Indeed, there is no automated mechanism to determine whether there is any benefits involved with implementing virtualization technology or, for that matter, the amount of the benefit (e.g., what is the reduction or increase in the total cost of ownership (TCO) of virtualization technology in a given system). To that end, the subject matter described herein provides a mechanism for determining the benefit of implementing virtualization technologies.

In one implementation, agents are provided in a system. The agents are used to gather (e.g., receive) information relevant to determining the benefit of implementing virtualization technologies. Moreover, the gathering of the information may be continuous and dynamic. Continuous refers to gathering relevant information in a periodic, uninterrupted, or nearly uninterrupted manner. Dynamic refers to gathering relevant information based on actual messages, such as commands, requests, and the like, used in the operation of a system. The gathered information is aggregated at a central data collector and stored in a storage device, such as a database or a file system. Moreover, information of a more static nature may be received and stored as well. Static information refers to information that is not considered dynamic, such as information representative of the amount of time it takes to manually install another physical computer, an hourly rate for information technology personnel installing an additional computer or server, the cost of an additional computer, and the like. The static information and the dynamic information are used to determine whether there is a benefit to implementing virtualization. The benefit may be provided as a cost reduction, TCO, or any other indication. Moreover, reports and/or alerts may be generated to allow a user to decide whether there is any benefit to implementing virtualization technology.

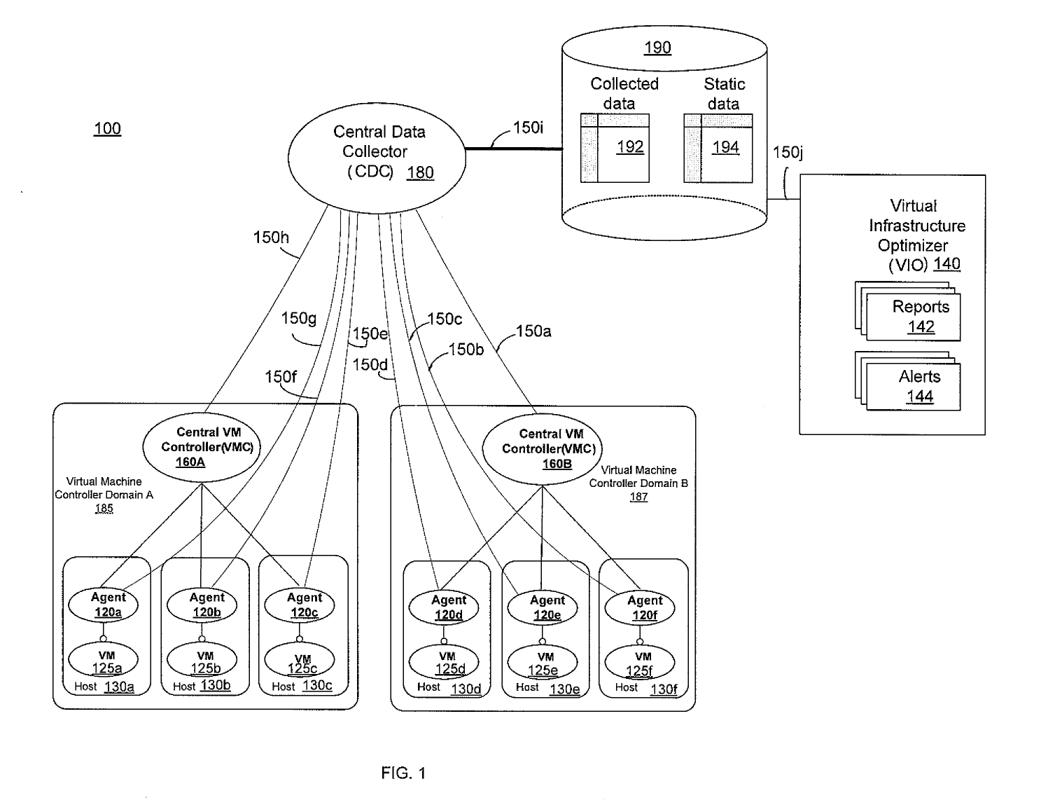

FIG. 1 depicts a system 100 for determining the benefit of implementing virtualization technology. System 100 includes virtual machines 125a-f, agents 120a-f, central virtual machine controllers 160a-b, a central data collector 180, a database 190, and virtual infrastructure optimizer 140, all of which are coupled by a communication mechanism 150a-j, such as the Internet, an intranet, a bus, interprocess communications, or any other communication mechanism.

The virtual machines 125a-f are implemented on hosts 130a-f. The virtual machine refers to software for creating a virtualized environment (i.e., a system) between the host and its operating system. The hosts 130a-f represent physical machines (e.g., processors, computers, servers, blades, and the like). The central virtual machine controllers 160a-b each control one or more virtual machines.

Agents 120a-f may gather information regarding the operation of each of the virtual machines 125a-f. For example, as virtual machine controller 160a controls and interacts with each of the virtual machines 125a-c, agents 120a-c receive messages and then analyze the messages to determine whether the messages are relevant for benefit analysis. If the information is relevant to benefit analysis, the information included in the message is sent by the agent to central data collector 180 for aggregation. For example, information relevant to the benefit analysis may correspond to one or more of the following: a command that triggers movement of a virtual machine from one physical machine to another physical machine (e.g., real-time migration); a command that suspends a virtual machine; a command that shuts down a virtual machine; a command that restarts a virtual machine; a command that increases or decreases an aspect of a virtual machine (e.g., varying processing capacity, varying memory, varying storage capacity, and/or varying network bandwidth); and any other information which may be relevant to determining the benefit of virtualization technology.

Moreover, agents 120a-f may also gather monitoring related information (e.g., information determined from commands) directly from a virtual machine without the virtual machine being called by the virtual machine controller.

In some implementations, an agent may map (e.g., transform) a proprietary message sent between a virtual machine controller and a virtual machine into a generic message format. For example, if the messages sent between virtual machine controller 160a and the virtual machines 125a-c are formatted in accordance with VMWare's proprietary message format, agents 125a-c may each map that proprietary message format into a generic format, such as a generic XML (eXtensible Markup Language) format, so that the generic message may be sent to the central data collector 180.

Moreover, when a system includes a plurality of different virtual machines, each using its own proprietary message format for messages between the virtual machines and virtual machine controllers, the use of a generic message enables the central data collector 180 to include information in a common format regardless of the type of virtual machine. Each of the agents 125a-f may be implemented as a program, group of programs, and/or small binary object (e.g., an applet) that performs one or more functions associated with gathering information relevant to benefit analysis.

The central data collector 180 receives information from agents 125a-f and aggregates that data in database 190. The aggregated data may be stored as collected data 192. Moreover, central data collector 180 may interact with central virtual machine controllers 160a-b to also gather data relevant to benefit analysis. For example, the central data collector 180 may send requests to the virtual machine controllers 160a-b to obtain information relevant to the benefit determination.

Database 190 may be implemented as any storage mechanism for storing collected data 192 and static data 194. For example, database 190 may be implemented as a database, a file system, or any other storage mechanism.

Static data 194 represents so-called “static” data relevant to the analysis of determining the benefit of implementing virtualization technologies, such as virtual machines. Examples of static data include one or more of the following: the number of physical machines and capabilities (e.g., number and type of CPUs (central processing unit), amount of memory, amount of network bandwidth); the number and type virtual machines, virtual machine controllers, and meta-virtual machine controllers; license fee amounts for the virtual machines, virtual machine controllers, and meta-virtual machine controllers; the cost of downtime of an application residing in a virtual machine; amount of time (e.g., in minutes or hours) to move applications from one physical machine to another physical machine; the capabilities of a virtual machine; electric power consumption of physical machines; cost of electric power consumption; and hourly rate of information technology staff. The static data 194 may be provided and/or gathered from other information sources, such as other databases on the Internet or provided manually by a user.

The collected data 192 represents so-called “dynamic” data. Examples of dynamic data include one or more of the following: duration of a move of a virtual machine from one physical machine to another physical machine (e.g., down-time); when a virtual machine is suspended, shut down, or restarted; variation (e.g., increases or decreases) in aspects of a virtual machine (e.g., varying processing capacity, varying memory, varying storage capacity, and/or varying network bandwidth); and any other information that may be relevant to determining the benefit of using virtualization technology.

The virtual infrastructure optimizer 140 may be implemented as a program on a processor to analyze the benefit of implementing virtual machines using the collected data 192 and the static data 194.

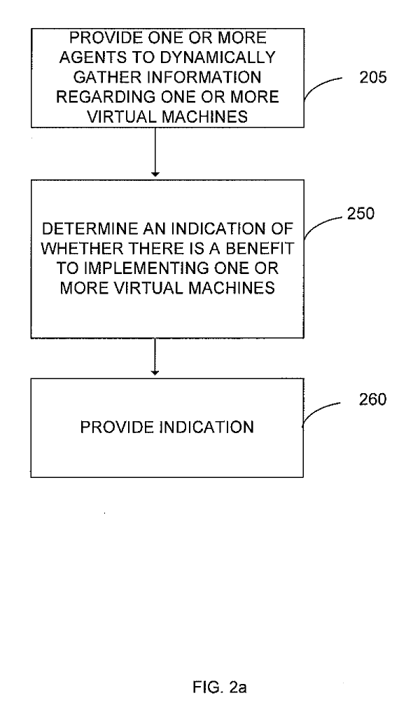

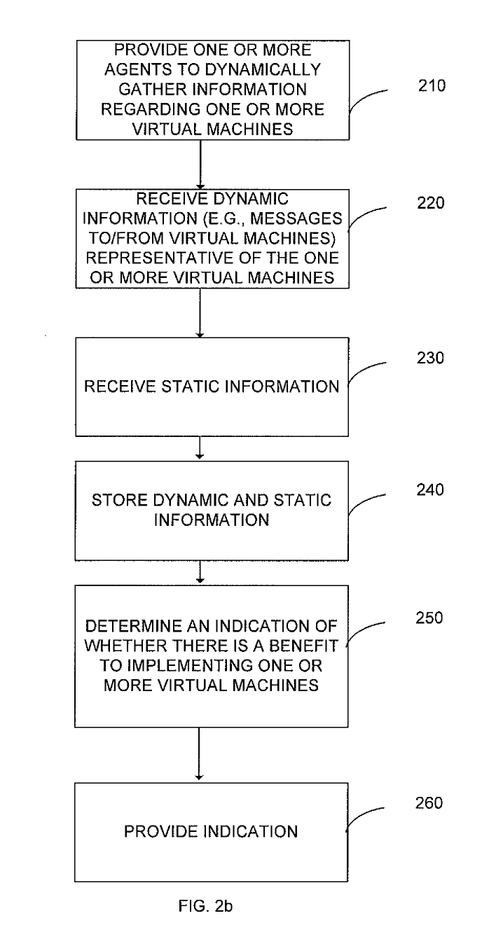

FIG. 2a depicts a process for analyzing the benefit of implementing virtual technologies.

At 210, information may be received which is relevant to determining the benefit of implementing virtualization technologies, such as virtual machines. The information may be gathered using one or more agents. Moreover, the information may correspond to at least one of dynamic information and static information. At 250, an indication may be determined. The indication may represent whether there is a benefit to implementing one or more virtual machines. Moreover, the indication may be determined based the received information gathered using the one or more agents. At 260, the indication may be provided to another program, such as a user interface for presentation.

FIG. 2b depicts another process for analyzing the benefit of implementing virtual technologies.

At 210, agents 120a-f may be provided to system 100 to gather information relevant to benefit analysis. In some implementations, agents 120a-f may be provided using, one or more of the following: a hot deployment feature; an upgrade or patch to the virtual machine; an upgrade or patch to the virtual machine controller; incorporated in the virtual machine; and incorporated in the virtual machine controller. Moreover, the agents 120a-f may be adapted to the system environment. For example, if an ABAP technology is used, the agent may be adapted to ABAP (e.g., written in ABAP, available from SAP, AG); if a J2EE cluster is used, the agent may be compatible with Java (e.g., a servlet, an Enterprise Java Bean, and the like); if a NET technology is used, the agent would be compatible with C# and the like.

At 220, agents 120a-f receive information (e.g., messages, commands, requests, and the like). The received information may correspond to messages including commands sent between the virtual machine controllers 160a-b and their respective virtual machines 120a-f. The messages may represent so-called “dynamic” collected data since such data represents the typically continuous (or near-continuous) activity or changes associated with virtual machines 125a-f as they operate in system 100. For example, virtual machine controller 160a may add additional storage to agent 120a. When this is the case, a message including the command is sent from virtual machine controller 160a to agent 120a to implement the added storage. The addition of storage is information relevant to benefit analysis. Specifically, the duration and cost to add storage to a virtual machine 125a may be compared to physically adding storage to an actual physical machine. For example, the time and cost to add storage to a virtual machine may be 10 seconds at a cost of 0.10 Euros, while the time and cost to add storage to a physical machine may be 1 hour at a cost of 1200.00 Euros (e.g., the hourly rate of the technician and the cost of a storage device). The message (or messages) associated with implementing the additional storage may then be sent to central data controller 180 for aggregation.

In some implementation, agents 120a-f receive information relevant to the benefit analysis over a predetermined period of time. For example, agents 120a-f may gather information for one hour, one day, one week, one month, or the like. Moreover, this information gathered by agents 120a-f may be continuous (e.g., periodic, uninterrupted, or nearly uninterrupted).

At 230, database 190 receives the so-called static data described above. The static data may correspond to any type of data not gathered at 220. Returning to the above example regarding the virtual machine controller 160a adding additional storage to agent 120a, static data 194 may correspond to the hourly rate of personnel, the amount of time it takes to physically install storage at a computer, and the financial cost associated with purchasing the storage, while the dynamic collected data 192 may correspond to the messages (or commands) initiating the additional storage at virtual machine 125a and any messages acknowledging that the storage has in fact been added.

At 240, the received dynamic data and static data are stored in database 190.

At 250, virtual infrastructure optimizer 140 determines an indication representative of the cost of ownership of the virtual machines based on the dynamically collected data 192 and the statically collected data 194. At 250, virtual infrastructure optimizer 140 may determine the benefit of implementing virtualization technology as a total cost of ownership based on the cost associated with a traditional physical system and the cost associated with a virtualization technology system, such as system 100. In some implementations, the following equation is used:

C_{BEN}=C_{TRAD}−C_{VIR} [Equation 1],

wherein C_{BEN} represents the benefit of implementing virtualization technology when compared to a traditional, physical system; C_{TRAD} represents the costs associated with operating the traditional, physical system; and C_{VIR} represents the costs associated with operating the virtualization-based system. Although Equation 1 is described herein, other ways of determining benefit may be used as well.

For example, collected data 192 may include data collected over a one month period. When this is the case, virtual infrastructure optimizer 140 may analyze all of the data 192 and 194 to determine information relevant to benefit analysis (e.g., changes, additions, deletions, suspensions, resumptions made in connection with memory, storage, network bandwidth, processing, and applications running in the virtual machines). Virtual infrastructure optimizer 140 may then determine C_{VIR} by analyzing the relevant information in collected data 192 as well as static data 194. For example, the total number of virtual machines running represent a license fee amount (i.e., a cost), the number of hosts 130a-f represent another cost, and so forth. Virtual infrastructure optimizer 140 may then determine C_{TRAD} by analyzing those collected data 192 as well as static data 194 to determine what the cost would be if only physical machines were used. For example, the costs of physically adding memory, storage, network bandwidth, and processing to run applications which would otherwise run in virtual machines, as well as the cost of additional hosts (i.e., physical machines). In some cases, C_{BEN} represents a benefit when running virtual machines, while in other cases C_{BEN} may represent that there is no benefit to running virtual machines or that fewer virtual machines may be implemented to attain optimum savings.

At 260, virtual infrastructure optimizer 140 may provide an indication regarding the benefit. The indication may be provided to a user interface, such as a browser or client application, in the form of a value (e.g., C_{BEN}, C_{TRAD}, and C_{VIR}), a report 142 indicating the benefit of implementing virtual machines, or as an alert 144. The alert 144 may be established to indicate when a predetermined cost savings is triggered. For example, an alert may be set to notify a user when more virtual machines (and thus virtual machine licenses) should be installed to take advantage of unused benefits that may be achieved by implementing virtual machines or, alternatively, when a user seeks to disable (or shutoff) one or more virtual machines (an implement one or more physical machines instead) to save some of the cost associated with the virtual machines (e.g., the license fees associated with each of virtual machines 125a-f). For example, when system 100 has few changes and additions, the benefit of using virtual machines may take longer to realize when compared to an environment where changes and additions occur more frequently. In the above example of an environment with fewer changes, the virtual infrastructure optimizer 140 may correspond to a smaller benefit (e.g., a smaller C_{BEN}).

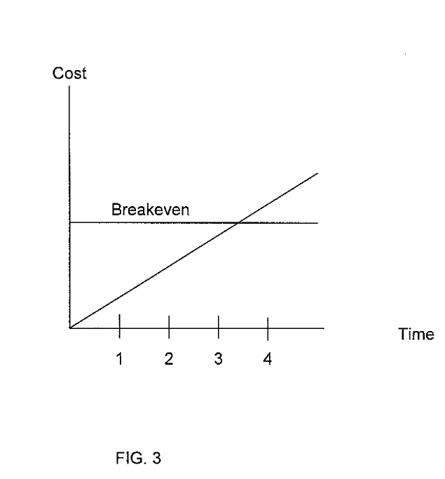

FIG. 3 depicts an example of a break-even point graph. The graph depicts the amount of time (e.g., 3 days, 3 months, 3 years, and the like) for a user of virtualization technology to recoup the cost associated with implementing such technology when compared to a traditional, physical approach that is not virtual. When the benefit (e.g., C_{BEN}) is relatively larger, the break-even point moves to the left (i.e., it takes less time to break-even), while a smaller benefit may move the break-even point to the right (i.e., it takes more time to break-even).

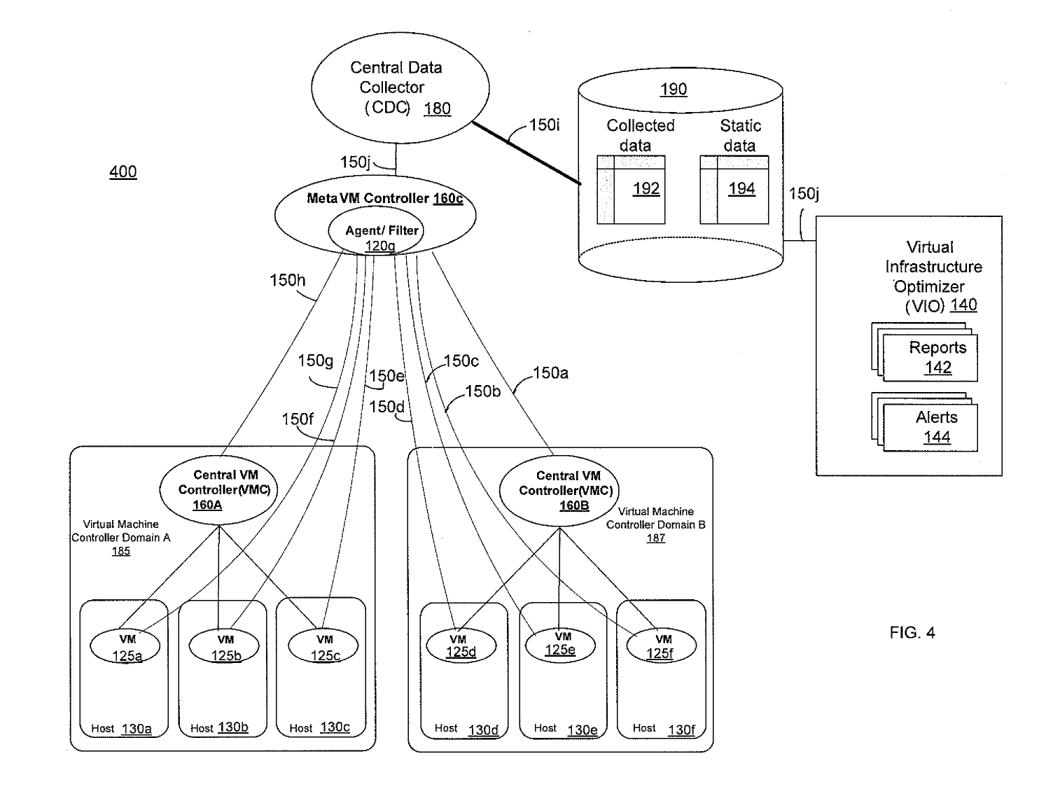

FIG. 4 depicts a system 400 for determining the benefit of implementing virtual machines. System 400 is similar to system 100 in many respects. However, system 400 implements a single agent 120g, which may be deployed in a meta-virtual machine controller 160c. The agent 120g receives messages exchanged between meta-virtual machine controller 160c and virtual controllers 160a-b as well as virtual machines 125a-f. The messages include information relevant to benefit analysis like the ones described above. As such, system 400 may be used with the process of FIGS. 2a-b.

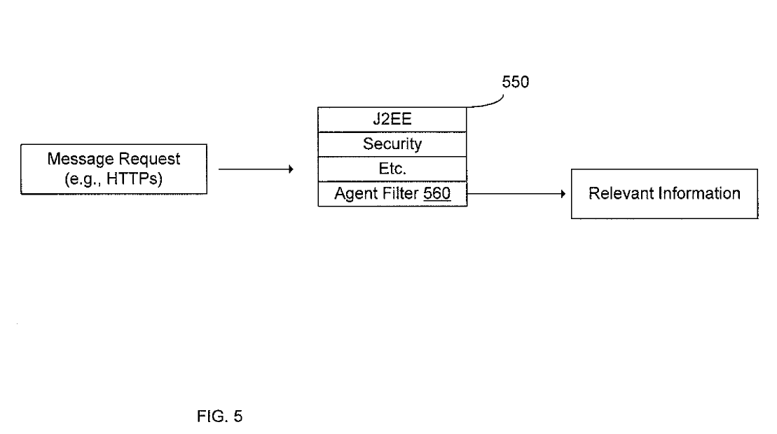

In some implementations, agent 120g may be implemented as a so-called filter. Specifically, it may be implemented as part of a series of filters that process connection requests (e.g., HTTPs (secure hypertext transfer protocol) connections) among virtual machine controller 160c, virtual controllers 160a-b, and virtual machines 125a-f. FIG. 5 depicts an example of such a filter stack. When a message is sent or received by meta-virtual machine controller 160c, the filter stack 550 processes the message. For example, each section of the filter processes the message by reading a relevant portion of the message. Agent filter 560 would thus process the messages and forward (to central data controller 180) any messages relevant to benefit analysis.

Although the above describes determining the benefit in terms of cost, the cost may be in any form representative of value, including gain, loss, time, or any other metric.

The systems and methods disclosed herein may be embodied in various forms including, for example, a data processor, such as a computer that also includes a database, digital electronic circuitry, firmware, software, or in combinations of them. Moreover, the above-noted features and other aspects and principles of the present disclosed embodiments may be implemented in various environments. Such environments and related applications may be specially constructed for performing the various processes and operations according to the disclosed embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the disclosed embodiments, or it may be more convenient to construct a specialized apparatus or system to perform the required methods and techniques.

The systems and methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The foregoing description is intended to illustrate but not to limit the scope of the invention, which is defined by the scope of the appended claims. Other embodiments are within the scope of the following claims.

What is claimed is:

1. A computer-readable medium containing instructions to configure a processor to perform a method, the method comprising:
receiving information gathered using one or more agents;
determining, based on the received information gathered using the one or more agents, an indication of whether there is a benefit to implementing one or more virtual machines; and
providing the indication.

2. The computer-readable medium of claim 1, wherein receiving further comprises:
receiving information over a predetermined period, the received information including dynamic information and static information; and
providing the indication to a user interface.

3. The computer-readable medium of claim 1, wherein receiving further comprises:
receiving information representing one or more of the following: varying processing, varying memory, varying storage, and varying network bandwidth.

4. The computer-readable medium of claim 1, wherein determining further comprises:
determining the indication as a cost of implementing the one or more virtual machines.

5. The computer-readable medium of claim 1, wherein providing further comprises:
providing the indication as a graph representative of when a cost of implementing the one or more virtual machines is recouped.

6. The computer-readable medium of claim 1 further comprising:
providing the one or more agents, the one or more agents receiving one or more messages exchanged in a system including the one or more virtual machines.

7. The computer-readable medium of claim 1 further comprising:
providing an agent to each of one or more virtual machines.

8. The computer-readable medium of claim 1 further comprising:
providing an agent to receive one or more messages from all of the one or more virtual machines.

9. The computer-readable medium of claim 8 further comprising:
implementing the agent to include a filter to process a hypertext transfer protocol request.

10. The computer-readable medium of claim 1 further comprising:
storing, in a centralized storage, the received information collected using the one or more agents, the centralized storage including at least one of a database or a file system.

11. The computer-readable medium of claim 1, wherein receiving further comprises:
mapping the received information into a format generic to a plurality of virtual machines.

12. The computer-readable medium of claim 1 further comprising:
adding a virtual machine based on the provided indication.

13. The computer-readable medium of claim 1 further comprising:
removing a virtual machine based on the provided indication.

14. The computer-readable medium of claim 1, wherein receiving further comprises:
receiving information including dynamic information gathered from commands sent to the one or more virtual machines.

15. A computer-implemented method comprising:
receiving information gathered using one or more agents;
determining, based on the received information gathered using the one or more agents, an indication of whether there is a benefit to implementing one or more virtual machines; and
providing the indication.

16. The computer-implemented method of claim 15, wherein receiving further comprises:
receiving information over a predetermined period, the received information including dynamic information and static information.

17. The computer-implemented method of claim 15, wherein receiving comprises:
receiving information representing one or more of the following: varying processing, varying memory, varying storage, and varying network bandwidth.

18. The computer-implemented method of claim 15, wherein determining further comprises:
determining the indication as a cost of implementing the one or more virtual machines.

19. The computer-implemented method of claim 1, wherein providing comprises:
providing the indication as a graph.

20. A system comprising:
a processor; and
a memory, wherein the processor and the memory are configured to perform a method comprising:
receiving information gathered using one or more agents;
determining, based on the received information gathered using the one or more agents, an indication of whether there is a benefit to implementing one or more virtual machines; and
providing the indication.
